(19) United States
(12) Patent Application Publication
(10) Pub. No.: US 2009/0172117 A1
(43) Pub. Date: Jul. 2, 2009

(54) METHODS FOR USING MESSAGE QUEUING TELEMETRY TRANSPORT FOR SENSOR NETWORKS TO SUPPORT SLEEPING DEVICES

(75) Inventors: Bharat V. Bedi, Southsea (GB); David C. Conway-Jones, Winchester (GB); Urs Hunkeler, Zurich (CH); Thomas J.W. Long, Wincanton (GB); Andrew J. Stanford-Clark, Chale (GB); Hong Linh Truong, Adliswil (CH); Nicholas C. Wilson, Petersfield (GB)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/968,466

(22) Filed: Jan. 2, 2008

(51) Int. Cl. G06F 15/16

(52) U.S. Cl. 709/206

(57) ABSTRACT

Methods support a sleep mode for an embedded device. Embedded devices like sensors and actuators used in wireless sensor networks have a limited power supply. To conserve energy and thus increase the lifetime of these devices, the devices should be put into a stand-by mode (also called sleep-mode) when they are not used. These methods support the sleep mode at a higher level than the MAC layer, thus avoiding the problems of prior art approaches. Methods are exemplarily described for the case of the message queuing telemetry transport protocol for sensor networks. They can easily be adapted to other protocols.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

The present invention generally relates to support of sleeping devices on wireless sensor networks, and more particularly, to methods for using message queuing telemetry transport for sensor networks (MQTT-S) to support sleeping devices.

2. Description of Background

Wireless sensor networks (WSNs) are gaining increased attention because of their potential for enabling novel and attractive solutions in areas such as industrial automation, asset management, environmental monitoring, and transportation. In many of these applications, sensors remain idle for long periods of time if no sensing event occurs. In the context of WSNs, these sensors include transmitters capable of transmitting sensed information using radio frequency (RF) energy. To save as much energy as possible, it would be desirable for sensors to turn off their transmitters and sleep during idle times. Sensors would need to wake up only when they have acquired new information to send.

Message queuing telemetry transport (MQTT) is a published protocol designed for use with simple devices such as sensors and actuators (SAs). MQTT-S is an extension of MQTT to sensor networks. MQTT-S is designed to operate in conjunction with low-cost, low-power SA devices running over bandwidth constrained WSNs such as Zigbee-based networks. Zigbee is an open, global standard for WSNs based on the IEEE 802.15.4 standard. Essentially, Zigbee adds networking, security, and application support functionalities to IEEE 802.15.4, with the aim of providing interoperability between products from different vendors. Zigbee and IEEE 802.15.4 are designed such that implementation on the client side (i.e., the SA side) is comparatively simple relative to implementation on the broker side.

MQTT and MQTT-S support basic end-to-end Quality of Service (QoS). Depending upon how reliably messages should be delivered to their receivers, they distinguish between three QoS levels. QoS level 0 is the simplest level. It offers a best effort delivery service, in which messages are delivered either once, or not at all, to a destination. No retransmission or acknowledgement is defined. Thus, QoS level 0 is appropriate for applications which can tolerate loss of a few messages. QoS level 1 provides a more reliable transport: messages with QoS level 1 are retransmitted until they are acknowledged by a receiver at the destination. Consequently, QoS level 1 messages are certain to arrive, but they may arrive multiple times at the destination because of the retransmissions. The highest QoS level, level 2, ensures not only the reception of messages, but also that they are delivered only once to the destination. It is up to an application to select an appropriate QoS level for its publications and subscriptions. For example, a temperature-monitoring application could decide to use QoS level 0 for the publication of normal and regular measurement reports, but QoS level 1 for transferring alarm messages when the temperature exceeds a certain threshold.

MQTT and MQTT-S are connection-oriented protocols in the sense that they require a client to set up a connection with the broker before the client can exchange publications and subscriptions with the broker. To this end, a CONNECT message is defined which contains a Client ID. The Client ID enables the broker to identify the connected client, and also to ensure that QoS level 1 and level 2 publications are delivered correctly even when the client reconnects after a network failure. The broker supervises the level of activity of the client connection using a keep-alive timer that defines the maximum allowable time interval that may elapse between two messages received from that client. If, during this time interval, the client has no data-related messages to be transmitted, the client has to send a PINGREQ message to the broker which is then acknowledged by the broker. Thus, the keep-alive timer enables the broker to detect a failure of either the client or a network link. A related feature is the support of the so-called Will concept. At connection time, the client may ask the broker to store a Will message together with a Will topic. The broker sends this Will message as a publication to subscribers when the broker loses its connection with the client by the keep-alive timer timing out. Applications could use this feature to detect persistent failures of links and devices.

There is a very important feature that is not supported by the current MQTT/MQTT-S protocol, namely the handling of duty cycles of the client devices. In many sensor applications, the sensor devices are idle for a long time if no sensing event occurs. To save as much energy as possible, it would be desirable for the client devices to enter a sleep mode when they are not used. The clients can wake up and publish data whenever the clients acquire new data. However, existing publish/subscribe protocols do not support sleeping devices. In the context of WSNs, support for sleeping devices has heretofore only been provided at the media access control (MAC) layer. Thus, prior art methods place a device into a sleep-mode state using protocols at a very low level. This causes problems as the upper protocol levels are unaware of these state changes.

It is difficult or impossible to utilize MAC-based sleep control mechanisms in networks where the broker is not connected directly to a wireless network, but instead connected through a gateway or router. Although a router could be used to buffer messages until a client device wakes up, the sleeping time could be quite long, on the order of several minutes to several hours. Since the router may serve a large number of clients, the number of messages to be buffered could easily exceed the storage capacity of the router. Moreover, as mentioned previously, in the case of QoS levels 1 and 2, the broker or gateway needs to receive an acknowledgment from the client to be sure that the client has correctly received a published message. It would not be possible to support QoS levels 1 and 2 if the published messages were to be stored for a long time at a router. In view of the foregoing shortcomings, what is needed is an improved technique for supporting sleeping devices on a WSN.

### SUMMARY OF THE INVENTION

Methods for using message queuing telemetry transport for sensor networks (MQTT-S) to support a sleeping client device on a wireless sensor network operatively coupled to a broker through a gateway, the methods comprising the broker receiving a CONNECT message from the client device, the CONNECT message specifying a client identifier and a keep-alive duration; monitoring the client device using a keep-alive timer set to the keep-alive duration wherein, if the broker does not receive a message from the client device for a period longer than the keep-alive duration, the broker associates the client device with a lost status and activates a will feature for that client device; the broker receiving a DISCONNECT message from the client device, the DISCONNECT message specifying a sleep duration; the broker acknowledging receipt of the DISCONNECT message to the client device; the broker associating the client device with an asleep status wherein, if the broker does not receive any message from the client device for a period longer than the sleep duration, the broker associates the client device with a lost status and activates the will feature and wherein, during the asleep status, the broker stores any messages for the client device as buffered messages; the broker receiving a PINGREQ message from the client device, the PINGREQ message specifying the client identifier, and in response to receipt of the PINGREQ message, associating the client device with an awake status; wherein, if the broker has no buffered messages for the client, the broker sends a PINGRESP message to the client device and associates the client device with the asleep status; wherein, if the broker has one or more buffered messages for the client device, the broker sends the one or more buffered messages to the client device upon receipt of the PINGREQ message by the broker; and wherein, after the one or more buffered messages are sent to the client device, the broker sends a PINGRESP message to the client device and associates the client device with the asleep status.

Other devices, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram setting forth an illustrative wireless sensor network (WSN) for use with the methods of the present invention.

FIG. 2 illustrates an exemplary message flow between a client and a gateway for implementing the methods of the present invention.

FIG. 3 describes the meanings of several symbols used in the flowchart of FIGS. 4-5.

FIGS. 4-5 together comprise a flowchart setting forth an illustrative operational sequence performed by a sleeping client.

FIG. 6 is a state diagram describing the manner in which a broker sees the state of a client.

The detailed description explains the preferred embodiments of the invention, together with advantages and features, by way of example with reference to the drawings.

### DETAILED DESCRIPTION OF THE INVENTION

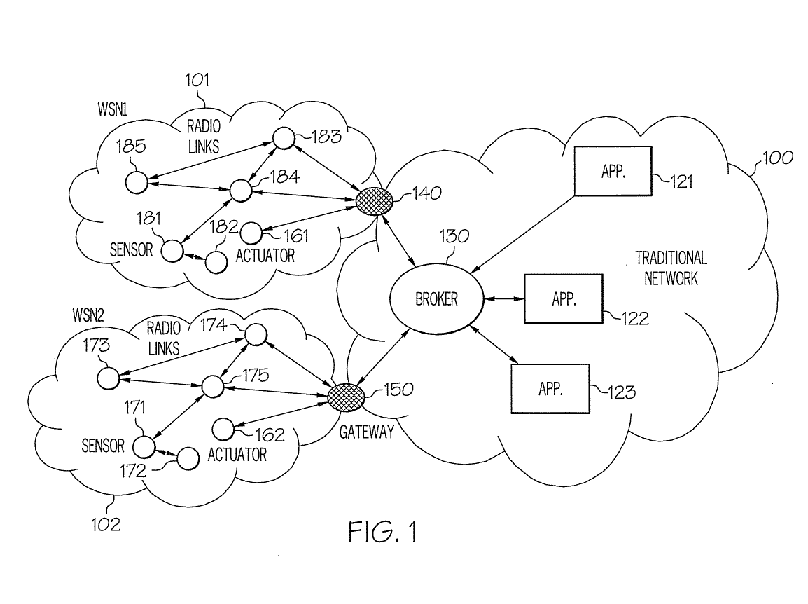

FIG. 1 is a block diagram setting forth an illustrative wireless sensor network (WSN) for use with the methods of the present invention. A traditional network 100, such as a local area network (LAN), wide area network (WAN), Ethernet, or wireless network, includes a broker 130 to which a plurality of applications 121, 122, 123 are connected. The broker 130 is operatively coupled to a first WSN 101 via a first gateway 140. The broker 130 is operatively coupled to a second WSN 102 via a second gateway 150. The first WSN 101 includes a plurality of sensors 181, 182, 183, 184, 185 operatively coupled to the first gateway 140 over one or more wireless links. First WSN 101 also includes an actuator 161. The sensors 181, 182, 183, 184, 185 and the actuator 161 each represent client devices. Similarly, the second WSN 102 includes a plurality of sensors 171, 172, 173, 174, 175 operatively coupled to the second gateway 150 over one or more wireless links. The second WSN 102 also includes an actuator 162. The sensors 171, 172, 173, 174, 175 and the actuator 162 each represent client devices.

Due to the fact that the broker 130 is not connected directly to the first WSN 101 or the second WSN 102, prior art techniques for supporting sleeping devices cannot be used. If the first and second WSNs 101, 102 were based upon the IEEE 802.15.4 or Zigbee standard, the first gateway 140 or the second gateway 150 could be used to buffer messages until a client device to which the message is directed wakes up. However, as the sleeping times of client devices could be very large (on the order of several minutes to several hours) and a gateway 140, 150 may serve a large number of clients, problems will result. As time goes by, the number of messages to be stored may exceed the capacity of the gateway 140, 150. Moreover, as mentioned previously, QoS levels 1 and 2 require the gateway 140, 150 or the broker 130 to receive an acknowledgment from the client device to be sure that the client has correctly received the published message. It would not be possible to support QoS levels 1 and 2 if the published messages were to be stored for a long time on the gateway 140, 150. Accordingly, pursuant to an illustrative embodiment disclosed herein, at least one of the gateway 140, the gateway 150, or the broker 130 are made aware of one or more sleeping times of a client device, and to store messages for the client device during the one or more sleeping times.

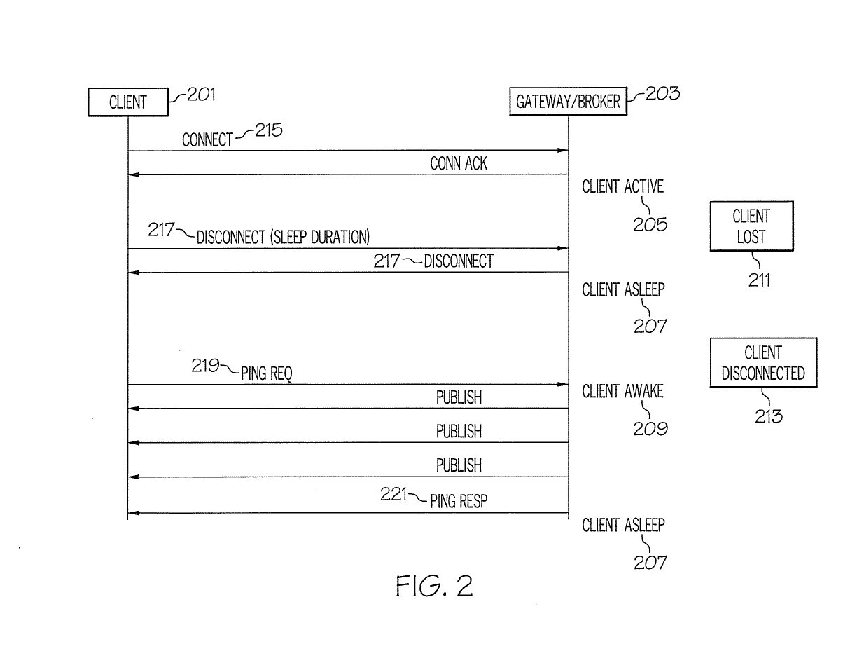

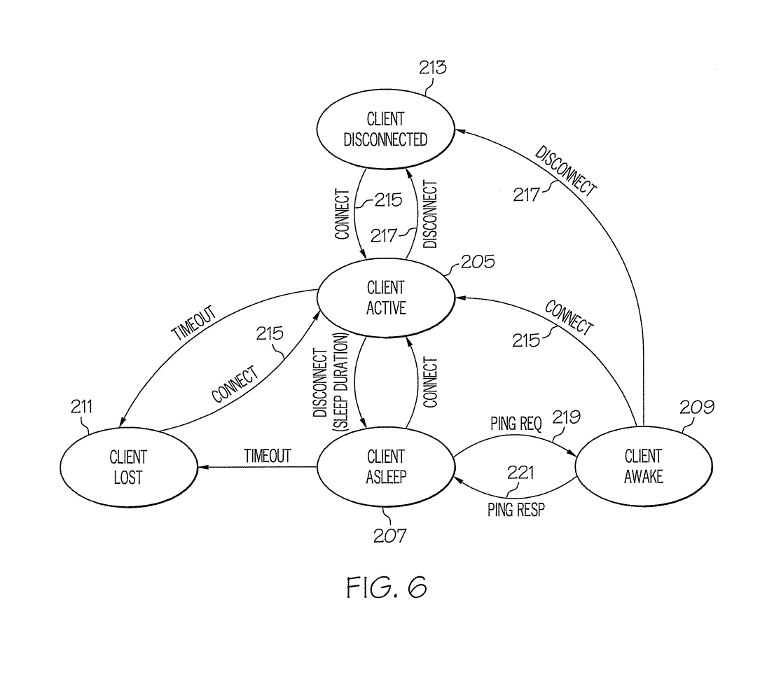

FIG. 2 illustrates an exemplary message flow between a client 201 and a gateway/broker 203 for implementing the methods of the present invention, and FIG. 6 is a state diagram describing the manner in which a broker sees the state of a client. Client 201 may represent any of sensors 171, 172, 173, 174, 175, 181, 182, 183, 184, 185, or actuators 161, 162 (FIG. 1). Likewise, gateway/broker 203 (FIG. 2) may represent any of the broker 130, the first gateway 140, or the second gateway 150 (FIG. 1). From the perspective of the gateway/broker 203 (FIG. 2), a client 201 may be in one of the following states: client active 205 (FIGS. 2 and 6), client asleep 207, client awake 209, client lost 211, or client disconnected 213. A client 201 is in the active 205 state when the gateway/broker 203 receives a first message from that client 201, illustratively in the form of a CONNECT 215 message. As with the current MQTT/MQTT-S protocol specification, the active 205 state is supervised by the gateway/broker 203 using a keep-alive timer, also referred to as a sleep timer. If the gateway/broker 203 does not receive any message from the client 201 for a period longer than a keep-alive time duration determined by the keep-alive timer (as indicated in the CONNECT 215 message), the gateway/broker 203 will consider that client 201 as being in the client lost 211 state and, for example, activates the will feature for that client 201.

A client 201 goes to the client disconnected 213 state when the gateway/broker 203 receives a second message from that client 201, illustratively in the form of a DISCONNECT 217 message without a sleep duration indication. The disconnected 213 state is not time-supervised by the gateway/broker 203. If a client 201 wants to sleep, the client 201 sends a DISCONNECT 217 message which contains a sleep duration. The gateway/broker 203 acknowledges that message with a DISCONNECT 217 message and considers the client 201 for being in the asleep 207 state. The asleep 207 state is supervised by the gateway/broker 203 with the aforementioned sleep duration. If the gateway/broker 203 does not receive any message from the client 201 for a period longer than the sleep duration, the gateway/broker 203 will consider that client 201 as being in the lost 211 state. Accordingly, as with the keep-alive procedure discussed previously, the gateway/broker 203 may activate the will feature for the lost client 201. During the asleep 207 state, all messages that need to be sent to the client are buffered at the broker/gateway.

The time “tolerance” of the sleep supervision at the gateway/broker 203 depends upon the value of the sleep duration. For example, the current MQTT implementation has a tolerance of 10% of the time for durations larger than one minute, and 50% if less.

The keep-alive timer is restarted when the gateway/broker 203 receives a third message, such as a PINGREQ 219 message, from the client 201. Like the CONNECT 215 message, the PINGREQ 219 message contains a client identifier (i.e., a client ID) identifying the client 201. The client 201 is then in the awake 209 state. If the gateway/broker 203 does not have any messages buffered for the client 201, the gateway/broker 203 answers the PINGREQ 219 message with a fourth message, such as a PINGRESP 221 message, and returns the client 201 to the asleep 207 state. If the gateway/broker 203 has one or more messages for the client 201, then the broker/gateway 203 sends these one or more messages to the client 201 when the gateway/broker 203 receives the PINGREQ 219 message. The transfer of messages is closed by the gateway/broker 203 by means of the PINGRESP 221 message. In other words, the gateway/broker 203 will consider the client 201 as being in the asleep 207 state after having sent the PINGRESP 221 message.

After having sent the PINGREQ 219 message to the gateway/broker 203, the client 201 uses a T_{retry} timer to supervise the arrival of messages sent by the gateway/broker 203. Essentially, the client 201 starts the T_{retry} timer when the client 201 receives any message other than a PINGRESP 221 message, and stops the T_{retry} timer when it receives the PINGRESP 221 message. The PINGREQ 219 message is retransmitted and the T_{retry} timer is started when the T_{retry} timer times out. To avoid unnecessary current drain in situations where the client 201 is powered by a battery, the client 201 may limit the retransmission of the PINGREQ 219 message. One illustrative method for limiting retransmission of the PINGREQ 219 message is by using a retry counter that initiates putting the client 201 back to sleep when a retry limit count of the retry counter is reached and the client still does not receive the PINGRESP 221 message.

From the asleep 207 state or the awake 209 state, a client 201 can return either to the active 205 state by sending a CONNECT 215 message, or to the disconnected 213 state by sending a DISCONNECT 217 message with no duration field included. The client 201 can also modify its sleep duration by sending a DISCONNECT 217 message with a duration field that specifies a new value of the sleep duration.

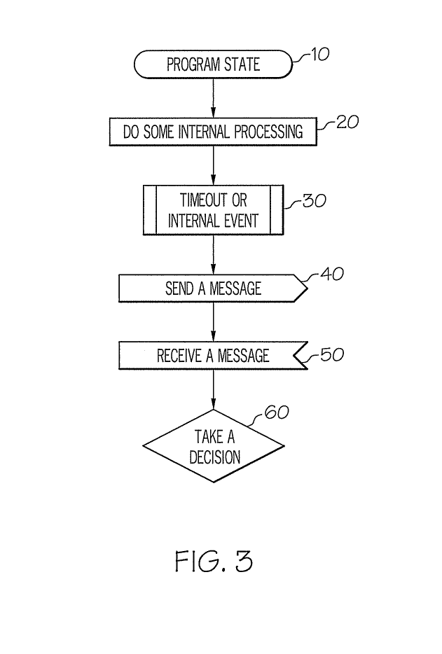

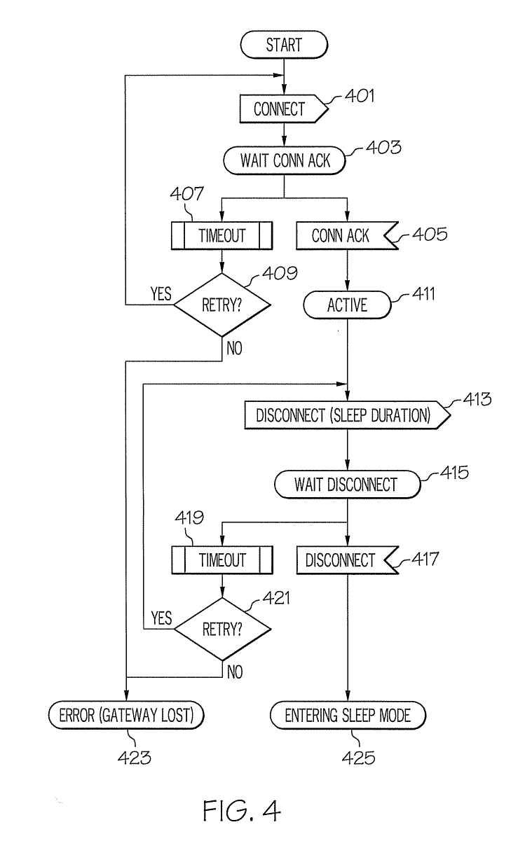

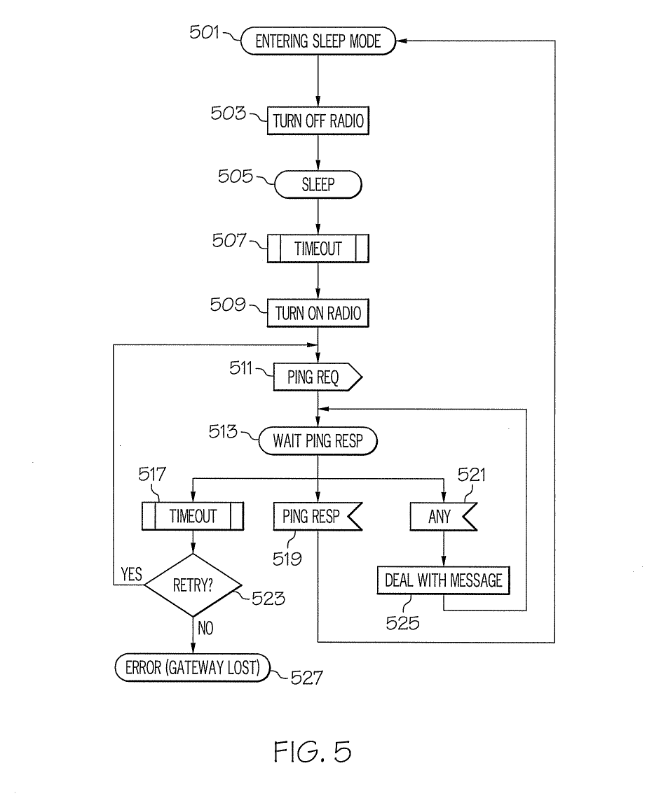

FIG. 3 describes the meanings of several symbols used in the flowchart of FIGS. 4-5. A first symbol 10 is used to represent a program state. A second symbol 20 is used to represent internal processing. A third symbol 30 is used to represent a timeout or an internal event. A fourth symbol 40 is used to represent a sending of a message. A fifth symbol 50 is used to represent a receiving of a message. A sixth symbol 60 is used to represent a decision.

FIGS. 4-5 together comprise a flowchart setting forth an illustrative operational sequence performed by a sleeping client 201 (FIG. 2) where the client first connects to a broker (such as gateway/broker 203) and then initiates a sleep state. Essentially, FIGS. 4-5 depict a state diagram for the client 201 (FIG. 2) in the context of the sleeping methodology previously described with reference to FIGS. 2 and 6. While in the sleep state, the client interacts periodically with the broker to tell the broker that the client is still available, and possibly to receive updates from the broker.

Referring to block 401 of FIG. 4, the client first connects to a gateway/broker 203 (FIG. 2), waits to receive an acknowledgment of the connection from the gateway/broker (FIG. 4, block 403), and either times out (block 407) while waiting for the acknowledgment, or receives the acknowledgment (block 405). If the time out occurs (block 407), a decision is made at block 409 to either try again by looping back to block 401, or to not try again by advancing ahead to block 423 where the gateway/broker is considered to be lost.

If the acknowledgment is received (block 405), the procedure advances to block 411 where the client goes into the active state. The client sends a DISCONNECT message that includes a sleep duration to the broker (block 413). The procedure temporarily remains in a wait DISCONNECT state (block 415), and either times out (block 419) or receives a DISCONNECT message (block 417). If the time out occurs (block 419), a decision is made at block 421 to either try again by looping back to block 413, or to not try again by advancing ahead to block 423 where the gateway/broker is considered to be lost. If the DISCONNECT message is received (block 417), the client enters the asleep state, also referred to as “sleeping mode” (block 425).

Referring now to block 501 (FIG. 5), the client enters the asleep state (i.e., sleep mode). At block 503, a transponder or transceiver (i.e., a radio) of the client is turned off. The client sleeps at block 505. A timeout occurs at block 507. The radio is turned on at block 509. A PINGREQ message is sent at block 511. At block 513, the client waits for a PINGRESP message. A timeout may occur (block 517), or a PINGRESP message may be received by the client (block 519), or another message may be received by the client (block 521). If the time out occurs (block 517), a decision is made at block 523 to either try again by looping back to block 511, or to not try again by advancing ahead to block 527 where the gateway/broker is considered to be lost. If the PINGRESP message is received (block 519), the procedure loops back to block 501. If another message is received by the client (block 521), then the client deals with this message (block 525), and the procedure loops back to block 513.

The procedures described with reference to FIGS. 2-6 permit one or more clients (such as client 201) to be easily implemented by low cost sensor devices. These procedures release gateways 140, 150 (FIG. 1), which are illustratively implemented using wireless routers, from buffering messages for the sleeping devices, thus allowing the routers to serve large numbers of sensor devices which may have relatively lengthy sleeping periods. The gateway/broker 203 (FIG. 2) is able to detect the loss of a client device (e.g., a persistent failure) not only while the client device is actively communicating, but also while the client device is sleeping.

The capabilities of the present invention can be implemented in software, firmware, hardware or some combination thereof. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While various preferred embodiments of the invention have been described, it will be understood that those skilled in the art, both now and in the future, may make various improvements and enhancements which fall within the scope of the claims which follow. These claims should be construed to maintain the proper protection for the inventions described herein.

What is claimed is:

1. A method for using message queuing telemetry transport for sensor networks (MQTT-S) to support a sleeping client device on a wireless sensor network operatively coupled to a broker through a gateway, the method comprising:
the broker receiving a first [hun1] message from the client device, the first message specifying a keep-alive duration;
monitoring the client device using a keep-alive timer set to the keep-alive duration wherein, if the broker does not receive a message from the client device for a period longer than the keep-alive duration, the broker associates the client device with a lost status and activates a will feature for that client device;
the broker receiving a second [hun2] message from the client device, the second message specifying a sleep duration;
the broker acknowledging receipt of the second message to the client device; the broker associating the client device with an asleep status wherein, if the broker does not receive any message from the client device for a period longer than the sleep duration, the broker associates the client device with a lost status [hun3]and wherein, during the asleep status, the broker stores any messages for the client device as buffered messages;
the broker receiving a third [hun4] message from the client device, and in response to receipt of the third message, associating the client device with an awake status; wherein, if the broker has no buffered messages for the client, the broker sends a fourth message to the client device and associates the client device with the asleep status;
wherein, if the broker has one or more buffered messages for the client device, the broker sends the one or more buffered messages to the client device upon receipt of the third message by the broker; and wherein, after the one or more buffered messages are sent to the client device, the broker sends the fourth message to the client device and associates the client device with the asleep status.

2. The method of claim 1 wherein, subsequent to the client sending the third message to the broker, the client uses a T_{retry} timer to supervise the arrival of messages sent by the broker, and wherein the client starts the T_{retry} timer when the client receives any message other than the fourth message, and stops the T_{retry} timer when the client receives the fourth message.

3. The method of claim 2 wherein the client retransmits the third message and restarts the T_{retry} timer when the T_{retry} timer times out.

4. The method of claim 3 wherein the client limits the retransmission of the third message by using a retry counter that initiates puffing the client in the asleep status when a retry limit count of the retry counter is reached and the client still does not receive the fourth message.

5. The method of claim 1 wherein a client can return from either the asleep status or an awake status to an active status by sending the first message, and wherein the client can return from either the asleep status or the awake status to a disconnected status by sending a second message with no duration field included therein; and wherein the client can modify its sleep duration by sending a second message with the duration field of the second message specifying a new value of a sleep duration.
